(19) United States
(12) Patent Application Publication
(10) Pub. No.: US 2015/0131082 A1
(43) Pub. Date: May 14, 2015

(54) VEHICLE, SYSTEM FOR RECEIVING AND TRANSMITTING OPTICAL SIGNALS, AND METHODS

(71) Applicants: Kornelis Jan Van Der Velde, Dalfsen (NL); Jasper Jeroen Rijnsburger, Zwolle (NL)

(72) Inventors: Kornelis Jan Van Der Velde, Dalfsen (NL); Jasper Jeroen Rijnsburger, Zwolle (NL)

(73) Assignee: PHYCO TRADING B.V., NIJKERK (NL)

(21) Appl. No.: 14/123,211

(22) PCT Filed: May 31, 2012
(86) PCT No.: PCT/NL2012/050378

§ 371 Date: Mar. 13, 2014

(30) Foreign Application Priority Data
May 31, 2011 (NL) 2006876

(51) Int. Cl. G01S 7/48; G01S 7/495; G01S 7/481

(52) U.S. Cl. CPC G01S 7/4806; G01S 7/4818; G01S 7/495
USPC 356/28

(57) ABSTRACT

Vehicle, provided with: —at least an optical passage (1) situated at a vehicle exterior for passing on optical signals (S1, S2); —at least an elongate optical signal guide (2), extending between said passage (1) and at least an optical signal processing unit (U) situated in the vehicle. The invention further provides a system for transmitting and receiving optical signals, as well as methods.

An aspect of the invention relates to a vehicle.

A further aspect of the invention relates to a system for transmitting and receiving optical signals.

In addition, the invention relates to methods for receiving and/or transmitting optical signals.

An example of a system as mentioned is a vehicle-mountable device for detecting optical signals from a vehicle speed monitor (for example, a laser gun), which device can send back laser pulses to jam the speed monitor.

Examples of laser transponders are described, for example, in U.S. Pat. No. 5,793,476 (Laakman et al.), for example, a laser transponder developed by the company Lidatek. The known transponder is arranged to be placed on the front of a vehicle, to detect incoming optical signals (for example, coming from a speed monitor) and to send back jamming signals. For determining the optical jamming signals, a large number of different methods are known, for example, transmission of a fixed pattern (independent of the incoming signals), or transmission of jamming signals specifically depending on observed signals.

One of the disadvantages of the known system is that installation as such is relatively difficult. In addition, it is usually hard to find a suitable location for the transponder. Thus, such a transponder is typically to be mounted on a vehicle front side, so that it can properly receive incoming signals, and to send jamming signals back in a suitable direction. Moreover, it is then relatively difficult to fit the transponder in a manner that does not impair the look of the vehicle. Moreover, the installed transponder can easily get damaged by objects entering during use, and is subject to rain and wind.

It appears that use of a single transponder does not always lead to good results. Thus, particular vehicle speed monitors irradiate only a small part of a vehicle. For this reason it has been proposed in known systems to provide a vehicle on the outside with different transponders at different locations, in order that incoming signals can be detected at different locations. That is a relatively costly solution, and augments the above-mentioned problems. Further, use of different transponders set up at a distance from each other entails a considerable increase of the use of electrical cabling to couple the various components mutually, which increases sensitivity to failure.

The present invention contemplates solving the above-mentioned problems. In particular, the invention contemplates an improved vehicle. According to a further aspect, the invention contemplates a reliable and durable system which can be installed relatively simply.

A vehicle according to the invention is characterized by the features of claim 1. The vehicle is provided with:
at least an optical passage situated at a vehicle exterior for passing on optical signals, and
at least an elongate optical signal guide, extending between the passage and at least an optical signal processing unit situated in the vehicle.

The vehicle provided by the invention provides various advantages. In particular, for example, incoming optical signals can be received via the optical passage, to be supplied by the elongate signal guide to the signal processing unit, for further processing. In addition, the optical signal processing unit can, for example, generate optical signals and send them out of the vehicle via an elongate signal guide and a respective optical passage.

During use the vehicle may, for example, only receive one or more optical signals via an optical passage and respective elongate signal guide, or only transmit one or more optical signals via an optical passage and the signal guide, or both receive and transmit one or more optical signals via the passage and guide. The optical signals can then serve various purposes, for example, determination of a distance between the vehicle and an object situated in surroundings of the vehicle, a measurement of the speed of the vehicle itself (for example, utilizing a series of the distance determinations mentioned), jamming of an external vehicle speed monitor, remote control of, for example, a gate or garage door, or a combination of these or other applications.

According to a further elaboration, each signal guide is an elongate flexible signal guide. Such a signal guide can be simply installed, and be laid out along a suitable path in the vehicle. Preferably, the guides are placed in the vehicle V in a simple manner, being fed through via existing openings in the vehicle (for example, between different compartments in the vehicle V).

The signal guide can be made of relatively thin design, for example, with a maximum outer dimension (e.g., diameter) of not more than 3 cm, in particular at most 2 cm or less, for example, about 16 mm. The signal guide can comprise, for example, at least an optical fiber (e.g., a glass fiber). The signal guide can be relatively long, preferably having a length of more than about 0.5 m, for example, at least about 1 m. In addition, a signal guide can have, for example, a length of less than about 0.5 m, for example, a length of at least one cm.

The optical passage, which is situated, for example, in an exterior of the vehicle, may be implemented in different manners. The optical passage can comprise, for example, an opening, or a window which is provided with a light transmissive material, or may be configured otherwise. A maximum cross dimension of the optical passage can be, for example, less than 5 mm, so that the passage is hardly visible from surroundings of the vehicle. For that matter, an optical passage can also have a different dimension, having, for example, a greater maximum cross dimension. The optical passage can comprise, for example, at least a part of a gap or opening in an exterior of the vehicle, for example, a gap or opening between neighboring vehicle parts, for example, body parts, lighting, number plate, bumper, air passage(s) and/or other components.

The vehicle may be provided, for example, with at least two optical passages, for example, at a mutual distance of more than about 10 cm. In that case, at least two respective elongate signal guides may be provided for transmission of optical signals to and/or from each of these passages.

One or more of such passages may be situated, for example, at a front side, viewed in a main driving direction, of the vehicle, to send out optical signals to an area in front of the vehicle and/or receive optical signals therefrom. Further, one or more of such passages may be situated on a rear side (viewed in the main driving direction) of the vehicle, for exchange of optical signals with an area behind the vehicle. In addition, one or more of such passages may be situated on one or both sides of the vehicle.

The optical processing unit mentioned may be set up at a suitable location in the vehicle, for example, in or near a passenger space, on a dashboard, at a central console next to the driver, in an engine compartment, under a hood, and in any case preferably at a relatively great distance from an optical passage. The processing unit can thus be arranged in the vehicle, at a suitable, safe location. Moreover, in this manner, such a component can be prevented from disturbing the look of the vehicle. The optical signal guide can optically transfer optical signals between the processing unit and an optical passage, so that use of possible electrical cabling is avoided or limited to a considerable extent. This leads to a particularly trouble-free operation.

The optical processing unit may in itself be implemented in different manners, depending, for example, on the desired application or applications. Thus, the optical processing unit may include at least a receiver for reception of optical signals (coming in via a respective passage) passed on by a signal guide. An optical processing unit may include at least a transmitter to transmit optical signals via a signal guide. An extra advantageous transmitter comprises a laser. More particularly, at least an optical processing unit may be included which is provided with both one or more light signal transmitters and one or more light signal receivers. Further, the optical processing unit may, for example, be provided with a housing, which has one or more optical terminal ports to connect the one or more optical signal guides.

According to a further elaboration, the optical processing unit includes at least a data processor, arranged for processing data that are related to the optical signals. Such a data processor may, for example, be configured to cooperate with a transmitter and/or receiver as mentioned for the purpose of transmission and/or reception of optical signals.

It is then extra advantageous if the data processor has information available that is related to a length of an optical signal guide, in particular for the purpose of determining an optical path length through the respective guide. More particularly, the data processor may be arranged to use information that is related to the length of at least an optical signal guide, in the processing of information concerning optical signals to be transmitted and/or received. With such information, the data processor can provide an extra accurate processing, for example, in jamming a speed monitor as mentioned above and/or when an optional parking assistance function is carried out.

The data processor may be arranged to process signals that are related to optical measuring signals of a vehicle speed monitor, which optical measuring signals have been received by the vehicle via at least an optical passage.

The data processor may be arranged to use the optical signals for measuring or estimating at least a distance between the vehicle and an object situated in surroundings of the vehicle.

According to a further elaboration, the data processor may be arranged to process data with utilization of a neural network, to thereby offer, for example, a self-learning data processor which during use adjusts data processing in each case on the basis of at least a preceding data processing.

In a further elaboration, the vehicle is provided with a system for receiving and transmitting optical signals, which system comprises:
at least a receiver installable in a vehicle for reception of optical signals;
at least a transmitter, in particular, laser, installable in the vehicle, for transmission of optical signals;
a data processor installable in the vehicle, arranged for cooperation with the receiver and transmitter;
one or more optical signal guides, in particular optical fibers, installable in the vehicle, for guiding optical signals incident on the vehicle to the receiver and/or for guiding transmitted optical signals from the transmitter to a location situated at a distance from that transmitter.

Such system for transmitting and receiving optical signals may, for example, be built into a vehicle already, or be built into a vehicle afterwards. By the use of the components mentioned, building the system into the vehicle is relatively simple to carry out, preferably without the vehicle needing to be adapted. What can be avoided, for example, is that an exterior of the vehicle has to be provided with one or more optical transponders. Incoming signals can be simply introduced into the vehicle via the one or more optical signal guides, to be detected by the one or more detectors. Optical signals to be transmitted can be simply guided via the one or more optical signal guides, from transmitting means situated in the vehicle (i.e., one or more light sources, for example, a laser) to an exterior of the vehicle for the purpose of sending out.

According to a further elaboration, the data processor of the system is arranged to process signals that are related to optical measuring signals from a vehicle speed monitor, detected by the receiver. In that case, the data processor may be configured, for example, to control the transmitter such that jamming signals are transmitted with it, to jam the speed monitor.

In addition, the data processor may be arranged, for example, to use the signal guides, transmitter and receiver in a distance measurement, for example, to provide parking assistance. To this end, for example, the transmitter may be driven by the data processor to transmit at least an optical measuring signal, this measuring signal being sent out of the vehicle to a nearby object. The receiver can be used to receive a reflection of the transmitted measuring signal, coming from the object. Then, the distance to the object can be simply determined or estimated by the data processor, at least, by measurement or estimation of the time period between transmission and reception of measuring signal and reflection, and, for example, a distance-dependent signal can be delivered.

Furthermore, the invention offers a method for receiving optical signals, utilizing a vehicle according to the invention, the method comprising:
transmission of at least a first optical signal, which is incident on the vehicle from surroundings, via at least an elongate signal guide to at least a signal processing unit installed in the vehicle.

In this manner, optical signals can reliably and trouble-free be received by the vehicle and guided into the vehicle, to the receiver (which is preferably not directly visible from surroundings of the vehicle).

Analogously, the invention offers a method for transmitting optical signals, utilizing a vehicle according to the invention, the method comprising:
transmission of at least a second optical signal, generated by at least a signal processing unit installed in the vehicle, via at least an elongate signal guide to surroundings of the vehicle.

With extra advantage, a combined method is provided, wherein transmission of the first optical signals and the reception of the second optical signals are associated with each other.

In particular, a data processor may be applied for mutually associating transmission and reception of the signals. Thus, for example, a neural network may be applied to associate the optical signals with each other. In addition, for example, predetermined data, for example, data stored in a database, can be applied to mutually associate the optical signals.

The first optical signals may originate, for example, from a vehicle speed monitor, while the second optical signals are arranged for jamming the vehicle speed monitor.

In another application, in particular, a distance measurement, the first optical signals are reflections of the second optical signals.

The present invention preferably utilizes information that is related to a length of the optical signal guide, in particular for the purpose of timing the optical signals (for example, a correction with respect to an exterior of the vehicle, at least, a location of a respective optical passage).

Further advantageous elaborations of the invention are described in the subclaims. Now, the invention will be clarified on the basis of a non-limiting exemplary embodiment and the drawings. In the drawings:

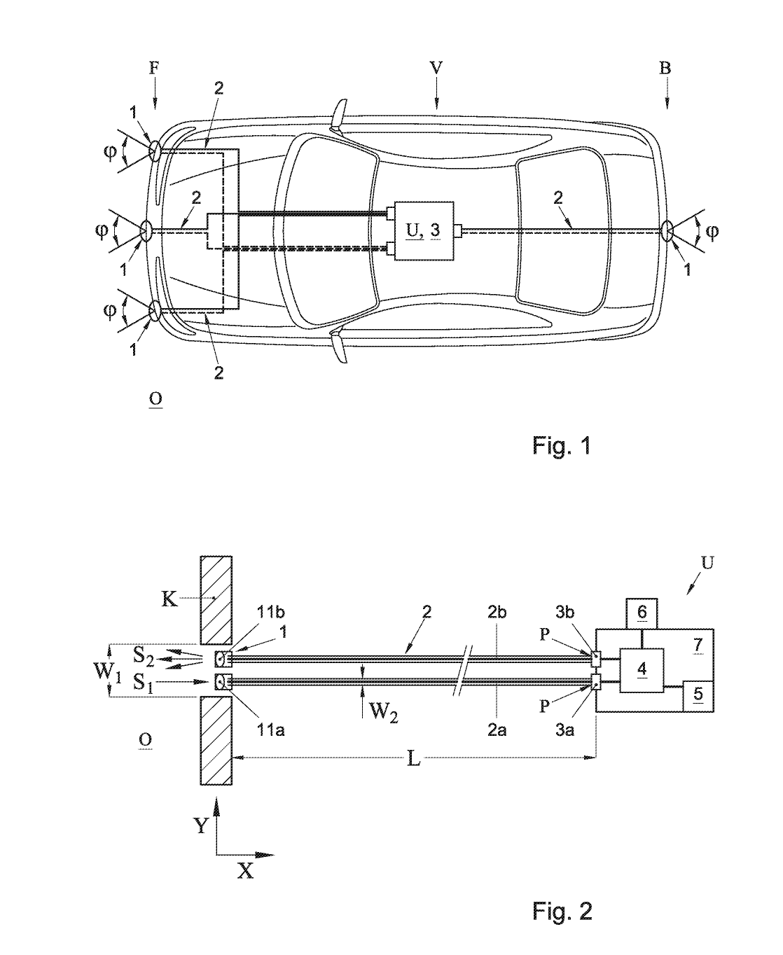

FIG. 1 shows schematically a system according to an exemplary embodiment of the invention;

FIG. 2 shows a part of the system represented in FIG. 1 in more detail;

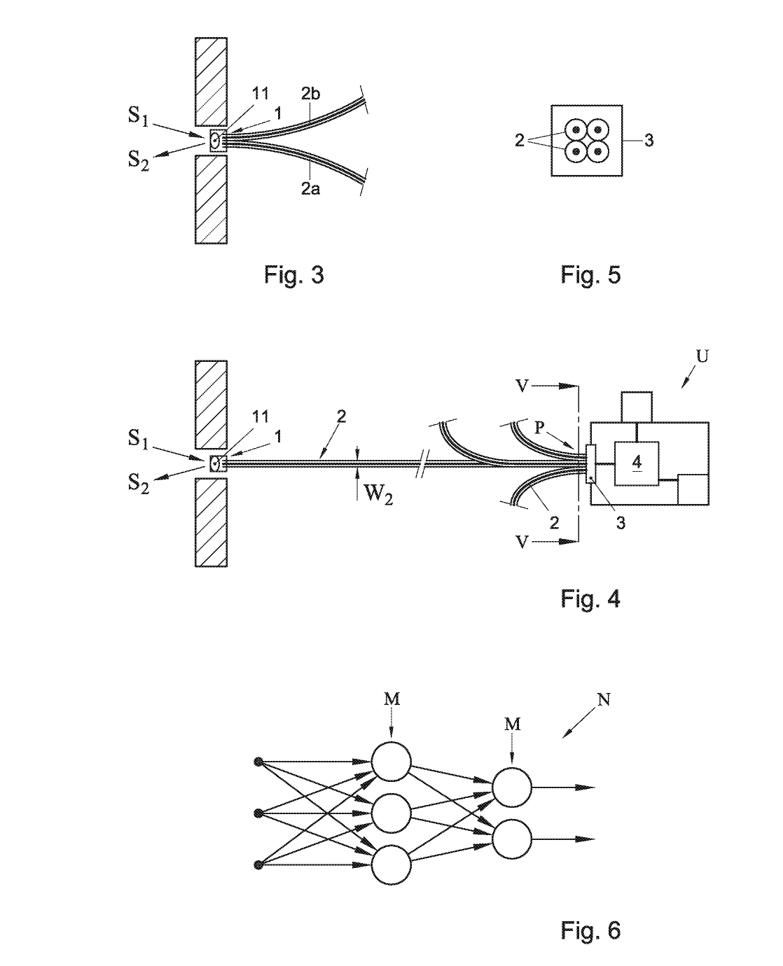

FIG. 3 shows an alternative elaboration of a part of the system;

FIG. 4 shows a further alternative elaboration of the system;

FIG. 5 shows a cross-sectional view taken along line V-V of FIG. 4; and

FIG. 6 schematically shows a neural network.

Like or corresponding measures are denoted in this application with like or corresponding reference signs.

FIG. 1 shows a vehicle V, provided with optical passages 1 (for example, entrance and/or exit windows), situated at (i.e., in) a vehicle exterior, for passing on optical signals S1, S2 (into and/or out of the vehicle). Further, the vehicle is provided with elongate optical signal guides 2, which extend between the passage 1 and a (in this case only one) optical signal processing unit U situated in the vehicle. In this non-limiting example, the signal guides 2 and signal processing unit U form a system for reception and transmission of optical signals S1, S2. The system has already been built into the vehicle V here; the schematic drawing in FIG. 1 is partly cutaway to make the system built in visible. FIG. 2 shows an example of the system 2, U in more detail.

In FIG. 1 the optical passages 1 have been drawn in schematically and comparatively large. In practice, one or more of these passages 1 can be relatively small with respect to the vehicle. Hereinabove, examples of suitable locations of such a passage have been mentioned, in particular, for example, at least a part of a gap or opening in an exterior of the vehicle.

FIG. 2 shows a passage 1 schematically in a cross section, where optical signals incident on the passage from surroundings O are drawn-in with arrow S1, and signals sent out via the passage with arrow S2. The passage 1 extends through a vehicle part K, which defines, for example, a part of a vehicle exterior. The passage 1 can, for example, be an opening, or a passage defined by a light-transmissive material (which material is substantially transmissive, in particular, of the optical signals S1, S2, for example, glass or a transparent plastic). A passage 1 may be provided with, for example, a watertight and/or airtight sealing transmissive of the signals S1, S2 (for example, a suitable cap, plate, or stuffing).

In a further elaboration, the vehicle V is already provided with the one or more signal passages 1 when the system 2, U (for reception and transmission of optical signals S1, S2) is built into the vehicle. In addition, one or more of the passages 1 may be provided in the vehicle V specifically for the purpose of transmitting optical signals (to/from one or more respective elongate signal guides 2).

According to a further elaboration, a maximum cross dimension W1, for example, a height or diameter, of an optical passage 1 is less than about 1 cm, for example, about 5 mm or less. A minimum cross dimension W1 of such a passage can be, for example, about 1 mm or more. A total surface of at least one of the passages 1 measured in the cross section (i.e., a section normal to a direction X drawn in FIG. 2), for example, of each signal passage 1, can be, for example, at most 1 cm², more particularly, for example, at most 0.25 cm². For example, an optical passage 1 may further have a length, measured in a direction X normal to a local vehicle exterior, of, for example, less than 10 cm, for example, a length in the range of about 1 mm 5 cm, or other length.

In the present example, the vehicle is provided with a number of locations (three, in this example) at a front side F which have optical passages 1, with respective signal guides 2. The vehicle front F is related to the forward main driving direction of the vehicle. A mutual distance between these front passage locations can be, for example, at least about 10 cm or more. For that matter, it is noted here that these front passages 1 may, for example, be separated from each other, or be part of, for example, a gap or opening in the front of the vehicle V. Further, the example is provided with an optical passage 1 at the rear of the vehicle, to receive and/or transmit optical signals there as well, utilizing a respective signal guide 2 and optical signal processor U. Preferably, the vehicle is (further) provided with at least one such optical passage in each side of the vehicle, to receive and/or transmit optical signals at the sides.

A passage 1 for optical signals S1, S2 is associated in each case with one or more elongate, preferably flexible, optical signal guide(s) 2 extending into the vehicle. As FIG. 2 shows, the signal guide 2 may be provided with a first end, near or in the respective passage 1, for reception of signals S1 from the surroundings which are incident on the passage 1 and/or for transmitting signals S2 via the passage 1 to the surroundings O of the vehicle V. Further, the signal guide 2 may be provided with a second end, which is coupled, for example, to the optical unit U, to exchange optical signals with it.

The signal guides 2 can each, in particular, include at least an optical fiber (for example, glass fiber), and, for example, have a length L of more than about 0.5 m, for example, at least about 1 m. As has already been mentioned, also shorter signal guides 2 can be used, which depends inter alia on a distance to be bridged by that guide 2 between the optical passage 1 and a processing unit U installed in the vehicle. In this example, the optical signal guides 2 (preferably optical fibers 2) can guide optical signals S1 incident on the vehicle to processing unit U, and transmit signals S2 from processing unit U to the surroundings O. The processing unit U is thus set up at a distance from the optical passage(s) 1, stably and in a safe location in the vehicle. As mentioned, advantageous locations of the unit U include, for example, a passenger space, a dashboard, a central console next to the driver, an engine compartment, under a hood, and the like.

Each signal guide 2 may in itself be implemented in different manners. The signal guide 2 can comprise, for example, a flexible optical cable, provided with one or more optical fibers and a protective sheath. The light guide 2 may be provided with a robust insulation, so as to be suitable for use in an engine compartment of a vehicle V. Preferably, each signal guide 2 is provided with just one central optical fiber so as to offer an extra thin configuration, but this is not requisite.

A maximum outside diameter of an optical cable may be, for example, within the range of about 1 to 30 mm, or of a different size. According to a further elaboration the guide 2 has a maximum outside dimension (for example, diameter) of about 2 cm or less. One or more of the signal guides 2 may furthermore, for example, each consist of a bare optical fiber, with a very small outside diameter (for example, a diameter of about 1 mm or less).

Installation of an optical signal guide 2, in the vehicle V, can be carried out in different manners. Preferably, the guide 2 is fixed to the vehicle at one or more locations through fixing means, for example, using tape, Velcro, clamping means, kit, and/or the like, such that the guide 2 is durably positioned along a desired path (and preferably at a distance from parts that move during driving).

An end of a signal guide 2 situated at a passage 1 may be coupled to that passage 1, for example, by means of a suitable connector (not shown), for example, a signal guide connector extending through the passage 1, a signal guide connector mounted on a nearby vehicle part K, or in a different manner.

The present vehicle V is provided with an optical processing unit U, having a housing 7, which, in particular, has at least a receiver 3a for reception of optical signals S1 passed on by one or more of the signal guides 2. In this case the unit U is additionally provided with a transmitter 3b for transmission of optical signals S2 via one or more of the signal guides 2.

The receiver 3a and transmitter 3b can each be implemented in different manners, which will be clear to the skilled person. Thus, an optical receiver 3a can comprise, for example, an image sensor, a photocell and/or may be implemented in a different manner. A transmitter 3b can, in particular, comprise one or more light sources. According to an extra advantageous elaboration, the transmitter 3b comprises a laser, for example, a semiconductor laser (e.g., one or more laser diodes). The transmitter 3b may be arranged to transmit, for example, infrared optical signals S2, at least, signals S2 of which a wavelength is only in the infrared spectrum, or other signals. The wavelength mentioned can be, for example, in a range of about 850-1000 nm, for example, 905 nm, or other range.

In this example, the receiver 3a may be arranged to detect in any case incoming optical signals S1 having a wavelength that is the same as a wavelength of signals S2 to be transmitted by the transmitter 3b. More particularly, the receiver 3a may be implemented to detect infrared optical signals S1, at least, signals S1 of which a wavelength is in a range of about 850-1000 nm, for example, 905 nm, or other range.

In case a separate receiver 3a and transmitter 3b are used, the processing of optical signal reception and transmission may be carried out, for example, simultaneously. It is then possible, for example, to separate the sensitive electronics of the receiver 3a from the electronics of the transmitter 3b, which is of benefit to the sensitivity of the whole.

The transmitter 3b and receiver 3a can jointly form an optical transceiver 3, which is shown in the example according to FIGS. 4-5. Such a transceiver 3 can receive the optical signals S1 coming in via guides 2, and send signals S2 into the guides 2. In case of such a combined transmitter/receiver 3, for example, a single light guide 2 is used for light transport in both directions. The signals S1, S2 going back and forth are then processed alternately.

According to a further elaboration, the vehicle V is provided with at least two optical signal guides 2, 2a which are associated with one optical receiver 3, 3a, such that optical signals S1 coming in via those signal guides are detectable by that one receiver 3, 3a. Further, the vehicle V may be advantageously provided with at least two optical signal guides 2, 2b which are associated with one optical transmitter 3, 3b, such that optical signals S2 transmitted by that transmitter are transmissible via the at least two optical signal guides 2, 2b.

Thus, FIG. 5 shows a further elaboration, where ends of different signal guides 2 are bundled. Exteriors of the end parts of the guides 2 may, for example, touch each other, as in the drawing. The transceiver 3 is arranged to receive signals S1 from each of the guides 2 separately, or, at least, to be able to discriminate between the signals S1 incident from the various guides 2. Further, the transceiver 3 may be arranged to transmit, for example, the same signal S2 via the guides 2, or to transmit mutually different signals S2 via the different guides 2.

It is noted that the setup shown schematically in FIG. 5, with a bundling of ends of signal guides, may also be used in combination with a separate receiver 3a, the receiver 3a then being arranged to discriminate between the signals S1 incident from the various guides 2a.

Analogously, the setup shown schematically in FIG. 5, with a bundling of ends of signal guides, may also be used in combination with a separate transmitter 3b, while the transmitter 3b may be arranged to transmit the same or, conversely, mutually different, signals S2 into the respective guides 2b. According to a further elaboration, for example, a series of microlenses may be used to couple light coming from one transmitter 3b (e.g., a laser diode) efficiently into different signal guide fibers 2b. It will be clear that the light coming from one transmitter 3b (e.g., a laser diode) may also be coupled into different signal guide fibers 2b without use of microlenses.

Furthermore, it will be clear that an optical coupling between a signal guide 2 on the one hand and transmitter 3b and receiver 3a (or transceiver 3) on the other hand can be implemented in different manners, with or without utilization of one or more optical elements, for example, lenses and/or mirrors and/or filters.

Further, the housing 7 of the optical processing unit U may be provided with one or more optical terminal ports P to connect thereto the one or more optical signal guides 2, for example, detachably. Each terminal port of the housing 7 may be associated with a transmitter 3b and/or receiver 3a (and optionally be part thereof) to transmit and/or receive signals to/from a signal guide 2 connected to that terminal port.

As FIG. 2 and FIG. 3 show in further elaborations, an optical passage 1 may be associated with, for example, at least a first optical signal guide 2a for passing on received signals S1, and at least a second optical signal guide 2b for passing on signals S2 to be transmitted.

FIG. 4 shows an extra advantageous elaboration, in which an optical passage 1 is associated with a single optical signal guide 2 which serves both for passing on the received optical signals S1 and for passing on optical signals S2 (transmitted by transceiver 3) to be transmitted.

Preferably, one or more optical means are used to enlarge an aperture angle φ for reception of optical signals S1 at an optical passage 1. Examples of an aperture angle are schematically drawn-in in FIG. 1 with angles φ. The aperture angle φ for each of the different passages 1 can be substantially the same angle, or can include mutually different aperture angles. The aperture angle φ is, in particular, greater than about 10 degrees, more particularly, greater than about 20 degrees, more particularly, at least 30 degrees. The above-mentioned optical means (i.e., an ‘aperture angle enlarger’) can comprise, for example, a reflector and/or a lens, which is/are set up in or near the optical passage 1, such that signals S1 coming in within the desired aperture angle are thereby led into an end of an optical signal guide 2.

The present figures show, in particular, use of (positive) lenses 11, 11a set up in/adjacent to the passages 1 to enlarge the aperture angle φ (and for optical coupling-in of the respective one or more signal guides). A diameter of each lens 11, 11a may be, for example, equal to or less than a maximum cross dimension W1 of the respective optical passage 1. According to a further elaboration, each lens 11, 11a has a diameter that is in the range of about 1-20 mm, for example (though not limited to) a diameter that is less than about 5 mm.

For that matter, such a lens 11, 11a may be set up at different locations, for example, in the passage 1, outside thereof (i.e., on a vehicle exterior) or just behind the passage 1 in the vehicle V. Further, for example, in each case a lens system of at least two lenses may be provided to enlarge the aperture angle cp. Furthermore, the lens 11, 11a in itself may form a watertight and/or airtight sealing of a respective optical passage 1 (hence without a gap, visible in FIGS. 2-4, between the lens and a vehicle edge/side surrounding the passage). The lens 11, 11a can further provide protection to a signal guide 2 set up behind it.

It is noted that a lens 11, 11a can be chosen per desired situation, in particular as regards an aperture angle and/or diameter. A lens can have, for example, a fixed or variable focal distance.

In addition, in the example, optical means (in this example lenses 11, 11b again) are provided to enlarge the aperture angle of signals S2 to be transmitted via a passage 1. An aperture angle for transmission of signals S2 can be, for example, equal to an above-mentioned aperture angle φ for reception of signals S1, or can comprise a different angle.

It will be clear that the means 11, 11a, 11b to enlarge the aperture angle φ may be mounted in different manners. The means 11, 11a, 11b may, for example, be positioned at a fixed position with respect to a nearby end of a respective optical signal guide 2, and, for example, be fixed to the signal guide 2 in a desired position by means of a connection or coupling. According to an extra advantageous elaboration, these means 11, 11a, 11b have already been coupled to a corresponding signal guide 2 or integrated therewith before the guide 2 is built into the vehicle, thus allowing relatively fast and simple building in.

The example shown in FIG. 2 is provided with separate aperture angle enlargers 11a, 11b for the optical guides 2a, 2b for transmission and reception of signals. An extra compact configuration is shown in FIG. 3, where an aperture angle enlarger 11 is associated with both a first signal guide 2a (for passing on incoming signals S1) and a second signal guide 2b (for passing on signals S2 to be transmitted). In FIG. 4 the same aperture angle enlarger 11 serves for enlargement of the aperture angle for reception of signals S1 and for enlargement of the aperture angle for transmission of signals S2, by being associated with the signal guide 2.

Preferably, one or more optical filters are used to filter received signals S1. Such a filter, for example, may be part of the optical means 11, 11a, 11b for enlargement of an aperture angle, and/or may be implemented differently. In addition, such a filter, for example, may be part of a receiver 3a, 3, or be set up between the receiver and a corresponding signal guide 2a, 2. Further, such a filter, for example, may be combined with an optional watertight and/or airtight sealing of an optical passage 1. More particularly, a filter may be arranged to substantially pass light within a predetermined wavelength region, and to substantially not pass light outside of that wavelength region (for example, to absorb and/or reflect it).

In the examples, the optical processing unit U is provided with a data processor 4, which is arranged for processing data that are related to the optical signals S1, S2. The data comprise, for example, data generated by a receiver 3a, 3, for example, electrical measuring signals, concerning reception of the one or more optical signals S1. The data further comprise, for example, control signals for controlling a transmitter 3b, 3, for the purpose of transmission of one or more optical signals S2.

The data processor 4 preferably has information available that is related to a length L of the optical signal guide 2, 2a, 2b. Such information can comprise, for example, the physical length L of the signal guide, or an optical path length of light guided by that guide, or an amount of time it takes light to pass through the guide, or other information. The data processor 4 can use this information with great advantage in the processing of information concerning optical signals S1, S2 to be transmitted and/or received.

In particular, the guide length information may be used by the data processor 4 to accurately determine a moment when a signal S1 was received in the optical passage 1, before the signal S1 was guided by a guide 2, 2a to a receiver 3, 3a. The data processor 4 can apply a first time correction to a detection moment, concerning a detection of the signal S1 carried out by a receiver 3, 3a, which first correction is proportional to the length L of the respective optical signal guide 2, 2a (e.g., a time correction comprising this length L divided by the speed of light). A reception time at the optical passage 1 is then equal to the detection moment at the receiver minus the first time correction.

Similarly, the guide length information can be used by the data processor 4 to accurately determine a moment when a signal S2 is to be transmitted from the optical passage 1, taking into account the time it will take the signal S2 to pass from a transmitter 3, 3b through the signal guide 2, 2b. The data processor 4 can apply a second time correction to a transmission moment, concerning a transmission of the signal S2 carried out by a transmitter 3, 3b, which second correction is proportional to the length L of the respective optical signal guide 2, 2b (e.g., a time correction comprising this length L divided by the speed of light). A transmission time at the optical passage 1 then equals the transmission moment at the transmitter plus the second time correction.

Further, the system, for example, may be provided with a suitable supply 5, for example, to feed the parts of the unit U. The supply 5 can comprise, for example, a battery supply, an external supply, and/or may be implemented in a different manner. According to a further elaboration, the supply 5 can comprise a supply connection with a relatively ample input voltage range. The unit U may thus be connectible, for example, to a portable battery, but also to a motorcar accumulator or an external mains voltage adapter, which increases the field of application.

The system may further be provided with a user interface 6, which may be implemented in different manners. The interface 6, for example, may be wholly or partly combined with the unit U, or be set up wholly or partly at a distance therefrom and then be coupled to the unit U, for example, via a suitably wired or wireless connection. The interface 6, for example, can comprise a control panel, be provided with touch keys, press keys, utilize voice operation, be provided with a display, for example, a touch sensitive screen, be provided with a data transfer port (for example, to plug in a data carrier) and/or the like. The interface 6, for example, can utilize graphic light symbols and/or acoustic signals to alert a user (in particular a driver of the vehicle V).

According to an extra particular elaboration, the data processor 4 is arranged to process signals that are related to optical measuring signals S1 of a vehicle speed monitor (itself not represented), which optical measuring signals S1 have been received via at least an optical passage 1. In that case the data processor 4, for example, can warn a user that such signals S1 have been received. In addition, the data processor 4 may be arranged, for example, to transmit jamming signals S2. Optical jamming signals S2 to be transmitted may be composed in different manners, which will be clear to the skilled person. Preferably, jamming signals S2 to be transmitted depend on observed measuring signals S1, such that a good jamming of the monitor can be achieved and, for example, such that the monitor does not notice that it is being jammed (“stealth”).

In addition, the data processor 4, for example, may be arranged to use the optical signals for measuring or estimating at least a distance between the vehicle and an object situated in the surroundings of the vehicle (e.g., a wall, sidewalk, another vehicle, a person and/or the like). A result of such a measurement/estimate can be passed on via the interface 6 to the driver of the vehicle V. The data processor 4 can thus offer, for example, a parking assistance function, or be part of an adaptive cruise control system, or both.

Another function to be carried out by the data processor 4 can comprise, for example, a remote control, for example, for operation of a gate or garage door. In that case, the data processor 4 is configured to provide for transmission of remote control signals S2 that are suitable to control a unit to be operated (e.g., an actuator to move a gate or door).

Yet another function comprises, for example, remote control for unlocking the vehicle V, and/or for activation of vehicle accessories. In that case, one or more first signals S1 can be transmitted to the vehicle V by an external remote control, which signals S1 are received via optical passage(s) 1 and signal guide(s) 2, and are detected by the receiver 3. Depending on the received signal S1, the data processor 4 can undertake a corresponding action (i.e., vehicle unlocking and/or activation of one or more vehicle accessories).

Still another function comprises a “Pedestrian avoidance system”, whereby the data processor 4 can use the signals to detect pedestrians present in the vicinity of the vehicle V, and upon detection can take action (such as warning the driver, or having the vehicle perform a braking action or evading maneuver).

Further, the data processor 4 may, for example, be arranged to provide a vehicle number plate shield, by having, during activation, signals S2 transmitted for a particular protection period, which disenable legibility of a vehicle number plate.

A still further function of the system, to be optionally performed, comprises a blind spot detection, whereby one or more optical passages 1 are positioned to receive optical signals from an area that is not directly visible to a driver of the vehicle V.

The data processor 4 may be configured, for example, to perform only one of the above-mentioned tasks/functions, or to perform at least two of the tasks mentioned. The data processor 4 may, for example, be switchable, via the interface 6, to different modi to perform the different available functions.

It is noted that during use, for example, predetermined data, for example, data stored in a database, can be used to associate the optical signals S1, S2 mutually. An extra advantageous elaboration comprises use of a neural network N, to associate such optical signals S1, S2 mutually.

According to a further elaboration, the data processor 4 may be arranged to process the data mentioned utilizing a neural network N. The neural network N, for example, may be part of a data processing carried out by the data processor 4, while the neural network N has undergone a learning process (training) before the data processor is installed in the vehicle V. In particular, the data processor 4 may be programmed (or provided with suitable software) to form the neural network N.

Neural networks are known per se. FIG. 6 shows schematically an example of a known neural network N. The network N comprises a number of layers of neurons M. In this example, each neuron M from a particular layer has a connection with all neurons M from the preceding layer (these connections are drawn with arrows in FIG. 6). Each connection has a particular transfer function. The sum of all input values times their transfer function determines in each case the value of the neuron itself. The transfer function indicates the ‘weight’ of the connection, how strongly the signal arrives via that connection at the target neuron, and can be positive (stimulating) or negative (inhibiting). The neural network can utilize stored information and can learn knowledge during use. In particular, the network N can be trained, by repeatedly presenting input values with corresponding desired output values, and by adjusting the transfer functions on the basis of those values.

It is expected that use of such a network N is particularly advantageous in recognizing a vehicle speed monitor. In particular, the network N may be arranged for analyzing data patterns of different types of vehicle speed monitors, and for basing the signals S2 to be transmitted on those data patterns. Thus, a neural network N lends itself eminently well for real-time pattern recognition. Therefore, it is expected that such a network N will be particularly well able to recognize vehicle speed monitors' recognizable patterns, and to respond adaptively to a vehicle speed monitor that transmits signals S1 with random patterns.

Training of the network N can comprise, for example: presenting to the network N network input values which are related to signals S1 transmitted by a known type of vehicle speed monitor, with corresponding desired network output values which are related to desired optical (jamming) signals S2 to be transmitted. This training can be carried out for all available vehicle speed monitor types. The network input values can comprise, for example, a strength of a received signal S1, and a time duration and mutual time duration of signal parts.

As mentioned, the present invention presents a large number of examples. When using relatively thin flexible guides 2, it is possible to place optical passages 1 (e.g., detection apertures) at places difficult to access on a front and/or rear side of a vehicle V. Further, the optical guides 2 make it possible that corresponding electronics (the unit U) need not be placed in a vehicle engine compartment, so that such electronics can be made of more economical design. The guides 2 make it possible that the vehicle V can be simply provided with, or has been simply provided with, a plurality of optical passages 1, for example, to enhance detectability of an external light source. Replacing a guide 2 (for example, with a lens system) can be carried out fast and simply, without adaptation of the electronics.

It will be understood that the invention is not limited to the exemplary embodiment described. Various modifications are possible within the scope of the invention as set forth in the appended claims.

Thus, the term “a(n)” in this application can mean just one, at least one, or a number of.

Further, a system as mentioned can be simply installed in different kinds of vehicles, including, e.g., a motor vehicle, automobile, motorcycle, truck, a part of a motor vehicle, trailer vehicles hauled by a motor vehicle, e.g., truck trailer or mobile home, and/or a combination thereof.

In addition, it will be clear that a vehicle may also be provided with an optical passage situated on a vehicle exterior for passing on optical signals, and a corresponding elongate optical signal guide 2, which extends between the passage 1 and at least an optical signal processing unit U situated in the vehicle, without application of a transmitter or receiver as mentioned.

Further, the system, for example, may be of modular construction, for example, such that it can simply be expanded by addition of one or more optical signal guides. Further, a length of an optical signal guide, for instance, may be simply adapted to an available installation length. If a length of an optical signal guide is changed, it is preferred that the data processor 4 be provided with new (optional) information which is related to the length of the new optical signal guide (for example, utilizing the interface 6).

1. A vehicle, provided with:
at least two optical passages (1) situated at a vehicle exterior for passing on optical signals (S1, S2);
at least an elongate optical signal guide (2), extending between said passage (1) and at least an optical signal processing unit (U) situated in the vehicle,
wherein the optical processing unit (U) comprises a data processor (4), arranged for processing data that are related to said optical signals (S1, S2), wherein the data processor (4) is arranged to process signals that are related to optical measuring signals (S1) of a vehicle speed monitor, said optical measuring signals (S1) having been received via at least a said optical passage (1),
wherein the optical processing unit (U) is provided with at least a receiver (3a) for reception of optical signals (S1) passed on by a said signal guide (2),
wherein the optical processing unit (U) is provided with at least a transmitter (3b) for transmission of optical signals (S2) via a said signal guide (2),
characterized by:
the receiver (3a) and transmitter (3b) being a separate receiver and transmitter; —at least two first elongate signal guides (2a) for transmission of optical signals from the optical passages (1), the at least two first optical signal guides (2a) being associated with the same optical receiver (3a), such that optical signals (S1) coming in via those second signal guides (2a) are detectable by that one receiver (3a); and
at least two second elongate signal guides (2b) for transmission of optical signals to the optical passages (1), the at least two second optical signal guides (2b) being associated with the same optical transmitter (3b), such that optical signals (S2) transmitted by that transmitter (3b) are transmissible via the at least two second optical signal guides (2b).

2. A vehicle according to claim 1, wherein each said signal guide (2a, 2b) is an elongate flexible signal guide, in particular comprising at least an optical fiber, and preferably has a length of more than about 0.5 m, for example, at least about 1 m.

3. A vehicle according to claim 1, wherein a maximum cross dimension of said passage (1) is less than about 2 cm.

4. A vehicle according to claim 1, wherein a maximum cross dimension of said optical passage (1) is less than 1 cm.

5. A vehicle according to claim 1, provided with at least two said passages, at a mutual distance of more than about 10 cm.

6. A vehicle according to claim 2, provided with one or more said passages at a front side, viewed in a main driving direction, of the vehicle, and one or more elongate optical signal guides.

7. A vehicle according to claim 1, provided with one or more said passages at a rear side, viewed in a main driving direction, of the vehicle, and/or at least a side of the vehicle.

8-21. (canceled)

22. A method for receiving optical signals, utilizing a vehicle according to claim 1, the method comprising:
transmission of at least a first optical signal (S1), which is incident on the vehicle (V) from surroundings, via at least an elongate signal guide (2) to at least a signal processing unit (U) installed in the vehicle.

23. A method for transmitting optical signals, utilizing a vehicle according to claim 22, the method comprising:
transmission of at least a second optical signal (S2), generated by at least a signal processing unit (U) installed in the vehicle (V), via at least an elongate signal guide (2) to surroundings of the vehicle.

24. A method comprising a method according to claim 23, wherein reception of the first optical signals (S1) and the transmission of the second optical signals (S2) are associated with each other, wherein in particular a data processor (4) is applied for mutually associating transmission and reception of the signals (S1, S2).

25. A method according to claim 24, wherein a neural network is applied to associate the optical signals (S1, S2) with each other.

26. A method according to claim 24, wherein predetermined data, for example, data stored in a database, are applied to associate the optical signals (S1, S2) mutually.

27. A method according to claim 24, wherein the first optical signals (S1) originate from a vehicle speed monitor, wherein the second optical signals (S2) are arranged for jamming the vehicle speed monitor.

28. A method according to claim 24, wherein the first optical signals (S1) are reflections of the second optical signals (S2).

29. A method according to claim 23, comprising utilization of information which is related to a length of said optical signal guide for the purpose of timing the optical signals (S1, S2).

30. A vehicle according to claim 1, wherein the transmitter (3; 3b) comprises a laser.

31. A vehicle according to claim 1, wherein the optical processing unit (U) is provided with a housing (7), which is provided with optical terminal ports to connect said optical signal guides (2a, 2b).

32. A vehicle according to claim 1, wherein the data processor has information available which is related to a length of said optical signal guide.

33. A vehicle according to claim 32, wherein the data processor (4) is arranged to use information that is related to the length of at least a said optical signal guide (2a, 2b) in the processing of information concerning optical signals (S1, S2) to be transmitted and/or received.

34. A vehicle according to claim 33, wherein the data processor (4) is arranged to use the optical signals for measuring or estimating at least a distance between the vehicle and an object situated in surroundings of the vehicle.

35. A vehicle according to claim 1, wherein the data processor (4) is arranged to process data with utilization of a neural network.

36. A vehicle according to claim 1, comprising a system for receiving and transmitting optical signals, the system comprising:
at least a receiver (3a) installable in a vehicle, for reception of optical signals (S1);
at least a transmitter (3b), in particular laser, installable in the vehicle, for transmission of optical signals;
a data processor (4) installable in the vehicle, arranged for cooperation with said receiver and transmitter;
the optical signal guides (2a, 2b), in particular optical fibers, installable in the vehicle, for guiding optical signals incident on the vehicle to said receiver and/or for guiding transmitted optical signals from said transmitter to a location situated at a distance from said transmitter.

37. A system (2a, 2b, 3a, 3b, 4) for transmitting and receiving optical signals (S1, S2), the system comprising:
a receiver (3a) installable in a vehicle, for reception of optical signals (S1);
a transmitter (3b), in particular laser, installable in the vehicle, for transmission of optical signals;
a data processor (4) installable in the vehicle, arranged for cooperation with said receiver and transmitter;
at least two first optical signal guides (2a), in particular optical fibers, installable in the vehicle, for guiding optical signals incident on the vehicle to said receiver;
at least two second optical signal guides (2b), in particular optical fibers, installable in the vehicle, for guiding transmitted optical signals from said transmitter to a location situated at a distance from said transmitter.
